(19) United States
(12) Patent Application Publication
(10) Pub. No.: US 2013/0124372 A1
(43) Pub. Date: May 16, 2013

(54) INTEGRATED MULTI-LICENSOR APPLICATION AND DATA PURVEYANCE

(71) Applicants: Rene Bouw, Kirkland, WA (US); Roger Soulen Mall, Sammamish, WA (US); Christian Liensberger, Bellevue, WA (US)

(72) Inventors: Rene Bouw, Kirkland, WA (US); Roger Soulen Mall, Sammamish, WA (US); Christian Liensberger, Bellevue, WA (US)

(73) Assignee: MICROSOFT CORPORATION, Redmond, WA (US)

(21) Appl. No.: 13/297,207

(22) Filed: Nov. 15, 2011

(51) Int. Cl. G06Q 30/06

(52) U.S. Cl. 705/27.1; 705/26.1

(57) ABSTRACT

A single integrated offering includes a dataset license and a license to an application tailored for using the dataset. The dataset licensor and the application licensor are distinct entities. However, the integrated offering is electronically purveyed under a single offering price, in a public online marketplace and/or on licensor websites. In some cases, purveyance includes obtaining a purchaser's consents to the licenses, disclosing one or both of the licensors' identities, provisioning a purchaser with the dataset and the application, making payments to licensors, tax authorities, and/or other parties in response to a purchaser's payment, and reporting dataset/application usage to the licensors. Purveyor code permits cancelation of a purchase of the integrated offering only as a unified whole.

### BACKGROUND

An ever-increasing amount and variety of digital data is available online, in local networks, on mobile devices, and through other channels. Much data is made available as part of the publication of magazines, newspapers, blogs, technical journals, and other documents whose primary component is text directed at human readers, as opposed to the data itself being the primary component. However, much data is also published as a product in and of itself, or provided by subscription to a data service.

Data product and services are available from data publishers and other sources. For example, commercial data publishers provide fee-based access to databases, spreadsheets, and other datasets containing demographic, financial, geographic, scientific, economic, legal, entertainment, business, engineering, medical, and many other types of data. This data is consumed by users through software such as database management systems, web browsers, spreadsheet programs, mobile device apps, and other applications. Some companies offer both proprietary data and applications for accessing that data, while other companies offer only data, and still others offer only applications.

### SUMMARY

Because goals and capabilities of data publishers, application developers, and end users are in tension with one another, different approaches to purveying products and services may yield better results. Some embodiments described herein provide integrated multi-licensor application and data purveyance approaches for consideration.

Some embodiments combine, into a single integrated offering, a dataset from a dataset licensor and an executable application from an application licensor. The integrated offering is purveyed in an online public marketplace, on a licensor website, and/or in another electronic forum. The dataset has data which is subject to a schema that specifies data types and data relationships of data within the dataset. The application is designed to operate during execution on data values that are organized according to the dataset schema or a similar schema. The dataset licensor and the application licensor are independent legal entities, as opposed to the dataset and the application merely being a bundle produced by a single vendor. The dataset is subject to a dataset license, which has dataset terms and conditions offered by the dataset licensor. The application is subject to an application license, with application terms and conditions offered by the application licensor. However, the integrated offering is electronically purveyed under a single offering price.

In some embodiments, purveying the integrated offering includes obtaining a purchaser's consent to be bound by the dataset license, and separately obtaining consent to be bound by the application license. Some embodiments disclose the licensors' identities, while others do not. Some automatically provision a purchaser with the dataset and the application. Some automatically make payments to licensors, tax authorities, and/or other parties in response to a purchaser's payment. Some embodiments automatically report dataset/application usage to the respective licensors.

Some embodiments permit cancelation of a purchase of the integrated offering only as a unified whole. Thus, these embodiments do not recognize or routinely refuse attempted cancelation of only the purchase of the dataset license or attempted cancelation of only the purchase of the application license.

From an architectural perspective, some embodiments include a logical processor, a memory in operable communication with the logical processor, and other components. For example, some include an integrated offering residing in the memory and consisting substantially of licenses (as opposed to hardware), such as a dataset end-user license and an application end-user license. The licenses are combined in a single solution having a single price.

Some embodiments include a user interface residing in the memory. In some, a purveyor code performs integrated multi-licensor application and data purveyance. For instance, the purveyor code may obtain a purchaser's consents to be bound by the licenses, make payments as described above, report usage to licensors, and restrict cancelation options as discussed.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, at least one dataset, software (e.g., kernel and application software), and other items in an operating environment which may be present on multiple network nodes, and also illustrating configured storage medium embodiments;

FIG. 2 is a block diagram illustrating aspects of integrated multi-licensor application and data purveyance in an example architecture; and

FIG. 3 is a flow chart illustrating steps of some process and configured storage medium embodiments.

### DETAILED DESCRIPTION

### Overview

Goals and capabilities of data publishers, application developers, and end users are in tension with one another, which creates multifaceted challenges.

For example, data publishers are under pressure from their customers to provide the data in applications to make the data easier to consume, but many data publishers focus their efforts on ensuring quality data, leaving application development and sales outside their core competency. Thus, many of these publishers would like third party application developers to build value-added applications on top of their basic data-access applications. However, from a data publisher's perspective, current data reseller models are restrictive and imperfect, for reasons such as the following: data publishers want more visibility into who is using their data, and into how people are using their data; many data publishers are ill-equipped to build and manage a robust application developer ecosystem; many data publishers know little about how to cater to a full range of application developers, from a hobbyist hoping to sell a few thousand mobile apps all the way up to a multinational software company; many data publishers don't have the sales infrastructure to reach large markets.

From an application developer's perspective, current data reseller models are also restrictive and imperfect. If an application developer isn't large enough for a data publisher to engage, that developer may have difficulty licensing the desired data. Application developers also want to sell what they know (their apps) and don't necessarily want to sell the data. Many application developers don't want to be responsible for managing how people use third party data. Many application developers don't want to build a business and technical infrastructure to support third party data licensing.

Users generally want to buy simple solutions that work out of the box. However, for the reasons mentioned above, many application developers and content publishers do not sell these single turn-key solutions. Thus, from an end user's perspective, licensing, provisioning and managing applications and data separately is imperfect. If the user isn't large enough for the data publisher to engage, they may have difficulty licensing the data once they've purchased the app. The user is not guaranteed that the data and the app will work together as hoped. The user is often required to load and configure the app before using it. Non-technical users and/or non-subject matter experts on the data risk misconfiguring the data and app and getting incorrect information as a result.

One response to these observations and challenges would be for a single large company to create and/or acquire divisions to do data publishing and application development, and then offer users application-and-data bundles which were made by the large company's respective divisions and are licensed as a bundle by the large company. Another response would be to increase the technical training of end users, or to target only technically sophisticated end users. Other responses not discussed herein may also be possible.

However, some embodiments described herein take a different approach to these challenges, by providing a single unified application and data purchase with separate licenses from multiple licensors. Appropriate provisioning and other purveyance flow can improve the experience of the stakeholders, and reduce or remove barriers that limit data-rich application development and sales.

Some embodiments described herein may be viewed in a broader context. For instance, concepts such as datasets, applications, schemas, licenses, pricing, payment, and cancelation may be relevant to a particular embodiment. However, it does not follow from the availability of a broad context that exclusive rights are being sought herein for abstract ideas; they are not. Rather, the present disclosure is focused on providing appropriately specific embodiments. Other media, systems, and methods involving datasets, applications, schemas, licenses, pricing, payment, and/or cancelation are outside the present scope. Accordingly, vagueness and accompanying proof problems are also avoided under a proper understanding of the present disclosure.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, other mobile devices having at least a processor and a memory, and/or other device(s) providing one or more processors controlled at least in part by instructions. The instructions may be in the form of firmware or other software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit, such as a core in a simultaneous multithreading implementation. As another example, a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Application” means a browser, a stand-alone application, a mobile device app, or other software that interacts directly with a user through a user interface, e.g., a graphical user interface (GUI), a voice-controlled user interface, a keypad-controlled user interface, or a command line user interface.

“Kernels” include operating systems, hypervisors, virtual machines, BIOS code, and similar hardware interface software. An application relies on a kernel for most if not all access to hardware.

“Code” means processor instructions, data (which includes constants, variables, and data structures), or both instructions and data.

“Program” is used broadly herein, to include applications, kernels, drivers, interrupt handlers, libraries, and other code written by programmers (who are also referred to as developers).

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise beyond the scope of human performance alone. “Computational steps” are steps performed computationally. Neither “automatically” nor “computationally” necessarily means “immediately”.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)”, and so on, means that one or more of the indicated feature is present. For example, “dataset(s)” means “one or more datasets” or equivalently “at least one dataset”.

It is understood that “based on” means “based at least in part on” regardless of whether “at least in part” is recited, unless expressly stated otherwise.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as accessing, binding, canceling, combining, configuring, consenting, displaying, executing, identifying, integrating, making, obtaining, offering, operating, organizing, performing, permitting, presenting, provisioning, purveying, receiving, reporting, residing, specifying, subjecting, (or accesses, accessed, binds, bound, cancels, canceled, etc.), with regard to a destination or other subject may involve intervening action such as forwarding, copying, uploading, downloading, encoding, decoding, compressing, decompressing, encrypting, decrypting, authenticating, invoking, and so on by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a transitory signal on a wire, for example. Unless expressly stated otherwise in a claim, a claim does not cover a signal per se. A memory or other computer-readable medium is presumed to be non-transitory unless expressly stated otherwise.

Operating Environments

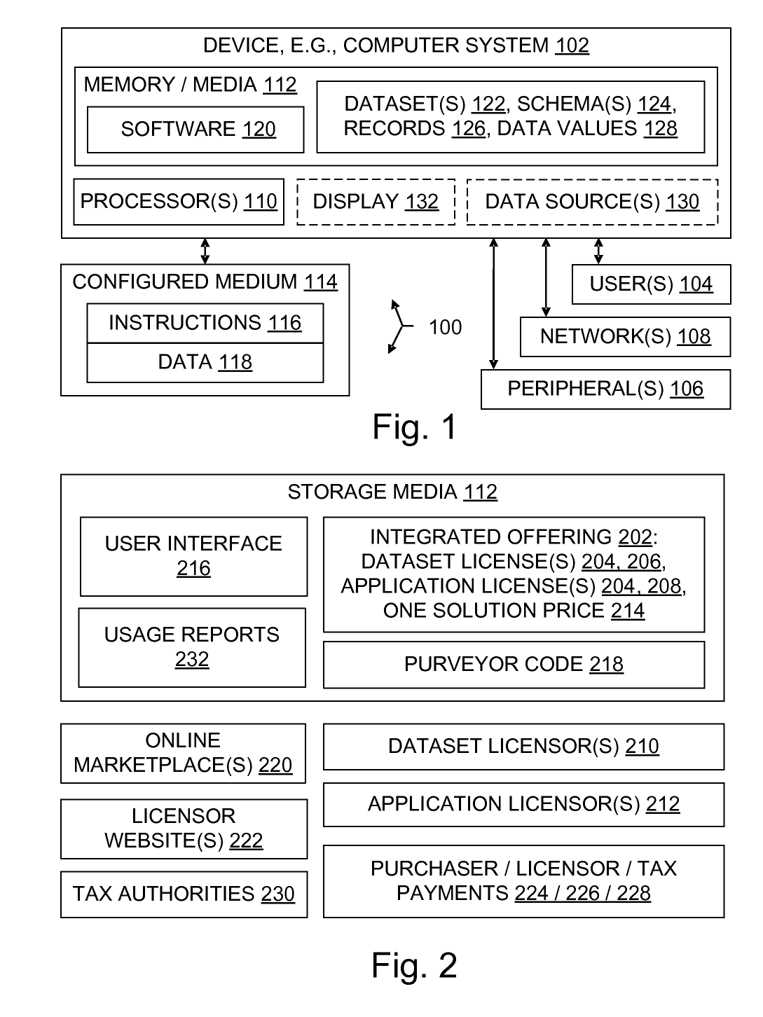

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked. An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106. System administrators, data publishers, application developers, engineers, testers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more computer-readable non-transitory storage media 112. Media 112 may be of different physical types. The media 112 may be volatile memory, non-volatile memory, fixed in place media, removable media, magnetic media, optical media, and/or of other types of non-transitory media (as opposed to transitory media such as a wire that merely propagates a signal). In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other storage devices which are not readily removable by users 104. Unless expressly stated otherwise, neither a computer-readable medium nor a computer-readable memory includes a signal per se.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by semantic categorization and otherwise as discussed herein.

A kernel, a web browser, other applications, and other software 120, as well as other items shown in the Figures and/or discussed in the text, may reside partially or entirely within one or more media 112, thereby configuring those media. A dataset 122 may have a schema 124 such as column names or an XML schema or a database schema, may have records 126 such as database records or spreadsheet rows, and does have data values 128. Datasets 122 are provided by data sources 130, e.g., web services, file systems, applications, network connections, marketplaces, and so on. “Marketplace” includes, for example, an online marketplace, such as a data and/or data enhancement services marketplace, as well as white-label or other marketplace versions that distribute to a closed group rather than the general public. In addition to the processor(s) 110, memory 112, and a display 132, an operating environment may also include other hardware such as buses, power supplies, and accelerators, for instance.

One or more items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

FIG. 2 illustrates an architecture which is suitable for use with some embodiments; reference is also made to FIG. 1. Some embodiments provide a computer system 102 with a logical processor 110 and a memory medium 112 configured by circuitry, firmware, and/or software to transform an application and dataset by extending functionality with integrated multi-licensor application and data purveyance as described herein.

For example, some embodiments include an integrated offering 202 residing in the memory 112 and consisting substantially of licenses 204, as opposed to comprising substantial hardware. In addition to the licenses 204, incidental non-hardware items may be present in the offering 202, such as promotional material, user guides and manuals, and/or digital certificates and other authentication/access control items. By contrast, a ready-to-use smartphone, laptop, or other product may include licenses but does not “consist substantially of licenses” because the product itself (unlike offering 202) includes substantial hardware in the form of a processor 110, a display 132, a network interface card, and/or a power supply.

In some embodiments, the integrated offering 202 includes at least one dataset end-user license 206 which identifies a dataset licensor 210 and also includes at least one application end-user license 208 which identifies an application licensor 212 that is branded separately from the dataset licensor. The dataset license(s) 206 and the application license(s) 208 are combined in a single solution (i.e., integrated offering 202) which has a single price 214 from the end-user's perspective.

Some embodiments include a user interface 216 residing in the memory 112. In some, a purveyor code 218 is included; the user interface 216 has its own reference number in FIG. 2, but may be part of the purveyor code 218 in some embodiments. Upon execution by the processor 110, the purveyor code 218 will perform integrated multi-licensor application and data purveyance, e.g., by obtaining through the user interface a purchaser's consent to be bound by the dataset license 206 and also separately obtaining through the user interface the purchaser's consent to be bound by the application license 208.

A wide variety of datasets 122 may be licensed by way of integrated offering(s) 202. In some embodiments, the dataset license 206 permits 338 access to a dataset 122 which contains at least one of the following: at least two hundred megabytes of data, at least one million data records, at least one hundred thousand data records, data from each of at least ten years, data from each of at least five years, data from each of at least five hundred counties, data from each of at least twenty countries, data for each of at least ten schema columns, data from each of at least six schema columns. In some, the dataset license 206 permits 338 access to a dataset 122 which contains at least one of the following: weather data, stock and/or bond data, housing cost data, demographic data, commodities price data, financial product usage data, latitude-longitude data, telephone number data, company name data, ewmail address data, sports data, social media data, web search related data.

In some embodiments, the integrated offering 202 includes at least two dataset licenses 206 for two respective datasets 122 from two respective dataset licensors 210, neither of whom is the application licensor 212. At least three licenses from at least three different licensors are present in the integrated offering 202, offered in combination under a single price 214 but with separate licenses 206, 208, and subject to cancelation only as a unified whole. Some embodiments of the integrated offering 202 include two application licenses 208 for two respective applications 120 from two respective application licensors 212, neither of whom is the dataset licensor 210, in combination under a single price 214 but with separate licenses 206, 208 and subject to cancelation only as a unified whole. Some embodiments of the offering 202 include two dataset licenses 206 for two respective datasets from two respective dataset licensors and two application licenses 208 for two respective applications from two respective application licensors, so at least four licenses from at least four different licensors are present in the integrated offering, offered in combination under a single price 214 but with separate licenses, and subject to cancelation only as a unified whole.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a system, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Some embodiments operate in a “cloud” computing environment and/or a “cloud” storage environment in which computing services are not owned but are provided on demand. For example, integrated offerings 202 may be purveyed on multiple devices/systems 102 in a networked cloud, offering datasets 122 may be stored on yet other devices within the cloud, and the offering applications 120 may configure the display on yet other cloud device(s)/system(s) 102.

Processes

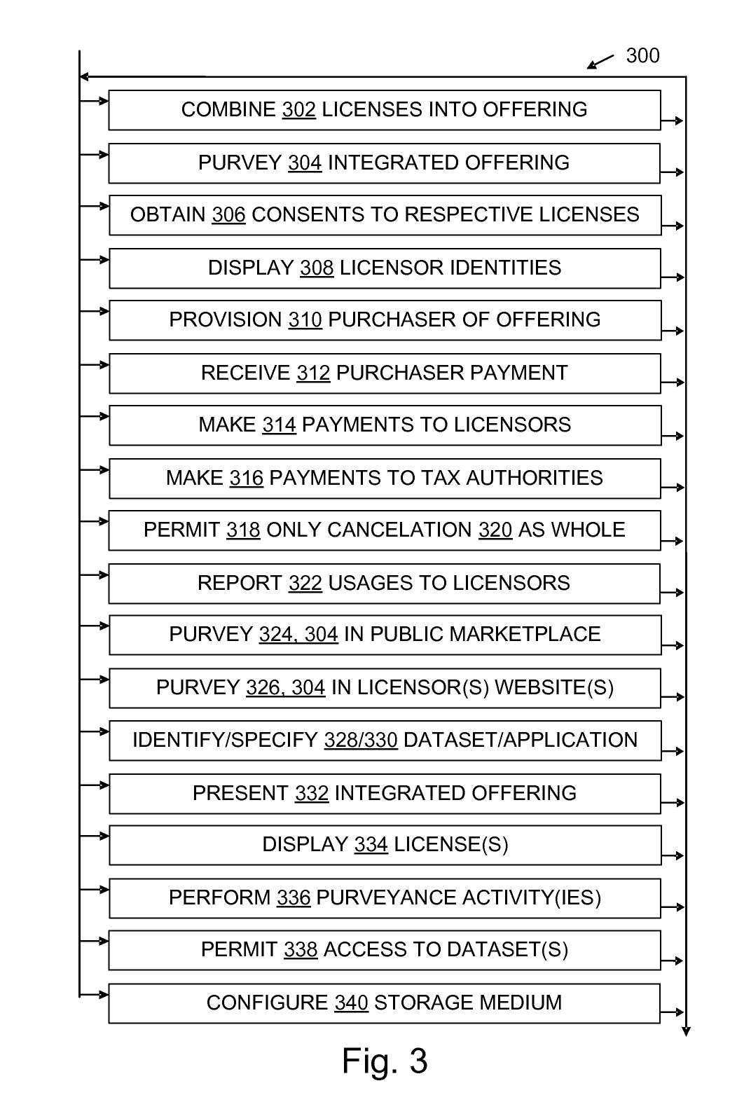

FIG. 3 illustrates some process embodiments in a flowchart 300; reference is also made to FIGS. 1 and 2. Processes shown in the Figures may be performed in some embodiments automatically, e.g., by purveyor code 218 under control of a script or otherwise requiring little or no contemporaneous user input. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

Some embodiments combine 302, into a single hardware-not-included integrated offering 202, a dataset 122 from a dataset licensor and an executable application software 120 from an application licensor. Combining step 302 may be accomplished by offering components which interoperate together, as described herein. The integrated offering 202 is purveyed 324, 304 in an online public marketplace 220, purveyed 326, 304 on a licensor website 222, and/or purveyed 304 in another electronic forum. The dataset has data values 128 which is subject to a schema 124 that specifies data types and data relationships of data within the dataset. The application 120 is designed to operate during execution on data values 128 that are organized according to the dataset schema 124, or a similar (e.g., shared column or other schema elements) schema. The application 120 is tailored to the dataset schema and similar schemas, in that the application lacks a majority of its functionality (form a user's perspective) in the absence of data values organized in such a schema.

In these embodiments, the dataset licensor 210 and the application licensor 212 are independent legal entities, as opposed to the dataset and the application merely being a bundle produced by a single vendor. The dataset is subject to a dataset license 206, which has dataset terms and conditions offered by the dataset licensor. The application is subject to an application license 208, with application terms and conditions offered by the application licensor. The dataset license and the application license differ from each other in at least one of their respective terms and conditions. Thus, licensed use of the combined dataset and application requires consent to at least two distinct licenses. However, the integrated offering 202 is electronically purveyed 304 under a single offering price 214, as opposed to purveying its separated components with a first offering price for the dataset component and a second offering price for the application component.

In some embodiments, purveying 304 the integrated offering includes obtaining 306 (e.g., in a dataset license action of consent) a purchaser's consent to be bound by the dataset license 206, and also includes obtaining 306 (in a distinct application license action of consent) the purchaser's consent to be bound by the application license 208. Obtained 306 actions of consent to a license may be pressing an “accept” button displayed with the license, entering an electronic signature to the license, using the licensed component after being notified that use constitutes acceptance of the license, and/or other legally effective action(s).

In some embodiments, purveying 304 the integrated offering includes proactively and automatically displaying 308 to a prospective purchaser the dataset licensor's identity and the application licensor's identity. In contrast, other approaches maintain anonymity of the licensors, e.g., by rebranding the offering's components.

In some embodiments, purveying 304 the integrated offering includes automatically provisioning 310 a purchaser 104 of the integrated offering with access to the dataset 122 and also automatically provisioning 301 the purchaser with the application 120.

In some embodiments, purveying 304 the integrated offering includes receiving 312 a single offering payment 224 from a purchaser of the integrated offering and then making 314, 316 payments 226, 228 to licensors 210/212, tax authorities 230, and/or other parties in response to the purchaser's payment. For example, some embodiments automatically make 314 a dataset licensor payment 226 to the dataset licensor 210 and/or make 314 a separate application licensor payment 226 to the application licensor 212. Some automatically make 316 a dataset tax payment 228 for a dataset tax which is associated with purveying the dataset and/or make 316 an application tax payment 228 for an application tax associated with purveying the application.

Some embodiments permit 318 cancelation 320 of a purchase of the integrated offering 202 only as a unified whole. Thus, these embodiments do not recognize (or routinely refuse) attempted cancelation of only the purchase of the dataset license 206 or attempted cancelation of only the purchase of the application license 208.

Some embodiments automatically report 322 usage of the dataset to the dataset licensor 210, and some separately automatically report 322 usage of the application to the application licensor 212. Care is taken to protect user privacy. For example, a usage report 232 does not necessarily include any personally identifiable information (PII) of a purchaser; aspects such as which data values are accessed, when they are accessed, and so on, may be reported only in the aggregate for multiple users, for example, or may be reported without identifying the purchaser by PII or otherwise. Notice of usage information collection is normally given, e.g., in the license(s) 204 and/or during execution of the application. Some embodiments are configured such that a purchaser must opt-in to the collection of usage information.

Some embodiments provide an approach to integrated multi-licensor application and data purveyance which includes identifying 328 a dataset having a dataset licensor 210, e.g., by receiving a dataset selection from a user or by noting that a dataset is compatible with an application in which a user 104 has indicated interest. The dataset has data which is subject to a schema that specifies data types and data relationships of data within the dataset. The approach also includes specifying 330 an executable application 120 having an application licensor 212 which is legally distinct from the dataset licensor, e.g., by direct user selection of the application or by noting that the application can operate on a dataset in which a user 104 has indicated interest. The application is designed to operate during execution on data values that are organized according to the dataset schema, and the application lacks a majority of its functionality in the absence of such data values.

These embodiments also include configuring 340 a computer-readable memory by presenting 332 online (e.g., in a web page or FTP directory) a single integrated offering 202 which combines the dataset and the application in a single software-only solution having a single price 214 but having separate dataset and application licenses for the dataset and the application, respectively. These embodiments display 334 the dataset license in a computing device (e.g., in a dialog box or popup window), obtain 306 through a user interface 216 of the computing device 102 a purchaser's consent to be bound by the dataset license, display 334 the application license in the computing device, and obtain 306 through the device's user interface the purchaser's consent to be bound by the application license.

Some of these embodiments include one or more aspects discussed above, such as automatically provisioning 310 the purchaser of the integrated offering with access to the dataset and the application; automatically making 314 licensor payments; automatically making 316 tax payments; automatically reporting 322 usage; and/or permitting 318 cancelation of a purchase of the integrated offering only as a unified whole, for example. Steps 308-334, which are performed by purveyor code 218, are collectively referred to as “purveyance activities” so one may also note that some embodiments perform 336 particular purveyance activities, and some perform 336 at least a certain number (exact or a range) of listed purveyance activities.

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as an integrated offering 202 or purveyor code 218, in the form of data 118 and instructions 116, read from a removable medium 114 and/or another source such as a network connection, to form a configured medium. The configured medium 112 is capable of causing a computer system to perform process steps for integrated multi-licensor application and data purveyance as disclosed herein. FIGS. 1 through 3 thus help illustrate configured storage media embodiments and process embodiments, as well as system and process embodiments. In particular, any of the process steps illustrated in FIG. 3, or otherwise taught herein, may be used to help configure a storage medium to form a configured medium embodiment.

### Additional Examples

Additional details and design considerations are provided below. As with the other examples herein, the features described may be used individually and/or in combination, or not at all, in a given embodiment.

Those of skill will understand that implementation details may pertain to specific code, such as specific APIs and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

The following discussion is derived from Microsoft® Windows® Azure™ Marketplace documentation (marks of Microsoft Corporation). Aspects of the Microsoft® Windows® Azure™ Marketplace program and/or documentation are consistent with or otherwise illustrate aspects of the embodiments described herein. However, it will be understood that Microsoft® Windows® Azure™ Marketplace documentation and/or implementation choices do not necessarily constrain the scope of such embodiments, and likewise that Microsoft® Windows® Azure™ Marketplace and/or its documentation may well contain features that lie outside the scope of such embodiments. It will also be understood that the discussion below is provided in part as an aid to readers who are not necessarily of ordinary skill in the art, and thus may contain and/or omit details whose recitation below is not strictly required to support the present disclosure.

In some approaches, a customer in the Marketplace buys a set of one or more applications from independent software vendors (ISVs) together with one or more datasets from content publishers. The user buys what is presented as one solution in the marketplace, namely, a unified group of components. As a result, the user 104 becomes a direct customer for all of the entities that provide components of the overall purchase, e.g., the application 120 developer(s) and the dataset 122 content publisher(s). During the purchase flow the single solution (integrated offering 202) is presented to the user as a collection of multiple components, forming one solution. As such, for each part of the purchase the user is called on to accept the relevant terms of use in the applicable licenses 204. The user buys the end-to-end solution without depending on a single unified license or other single set of terms for all components from only one responsible party. The quality of the solution may depend in part on how well the application ISV and content publisher have aligned their offerings and their respective licenses.

Once the licensing is done, the marketplace automatically provisions 310 the user to all of the component data and other services making up the single unified solution 202. The marketplace can facilitate this provisioning (which can use familiar mechanisms) and other aspects of purveyance, thus allowing developers to present compelling solutions without forcing the developers to become the customers or responsible parties for the data publishers.

In some approaches facilitation in the marketplace includes presenting 332 the solution as a single offer to purchase in the marketplace catalog; display of a single end user price 214 for the combined components; requiring the acceptance of the individual terms of use and providing details on how the components are bought from individual ISV's and publishers; and/or provisioning to the user all of the individual component services in the overall solution the user has purchased. Facilitation may also include managing the payment process on behalf of all of the solution component sellers and distributing the proceeds after purchase; user and/or usage reporting 322 to each of the sellers providing a component of the unified solution; and/or ensuring that cancelation of the combined offer is only possible as a whole.

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIG. 3 also help describe configured media, and help describe the operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computer-readable storage medium configured with data and with instructions that when executed by at least one processor causes the processor(s) to perform a process for integrated multi-licensor application and data purveyance, the process comprising the steps of:
combining into a single hardware-not-included integrated offering a dataset from a dataset licensor and an executable application from an application licensor, the dataset having data which is subject to a schema that specifies data types and data relationships of data within the dataset, the application designed to operate during execution on data values that are organized according to the dataset schema and lacking a majority of its functionality in the absence of such data values, the dataset licensor and the application licensor being independent legal entities, the dataset being subject to a dataset license with dataset terms and conditions offered by the dataset licensor, the application being subject to an application license with application terms and conditions offered by the application licensor, the dataset license and the application license differing from each other in at least one of their respective terms and conditions; and
electronically purveying the integrated offering under a single offering price, as opposed to purveying with a first offering price for the dataset and a second offering price for the application.

2. The configured medium of claim 1, wherein purveying the integrated offering comprises obtaining in a dataset license action of consent a purchaser's consent to be bound by the dataset license and obtaining in a distinct application license action of consent the purchaser's consent to be bound by the application license.

3. The configured medium of claim 1, wherein purveying the integrated offering comprises proactively and automatically displaying to a prospective purchaser the dataset licensor's identity and the application licensor's identity, as opposed to maintaining anonymity of the licensors.

4. The configured medium of claim 1, wherein purveying the integrated offering comprises automatically provisioning a purchaser of the integrated offering with access to the dataset and also automatically provisioning the purchaser with the application.

5. The configured medium of claim 1, wherein purveying the integrated offering comprises receiving a single offering payment from a purchaser of the integrated offering, automatically making a dataset licensor payment to the dataset licensor, and automatically making a separate application licensor payment to the application licensor.

6. The configured medium of claim 1, wherein purveying the integrated offering comprises receiving a single offering payment from a purchaser of the integrated offering, automatically making a dataset tax payment for a dataset tax which is associated with purveying the dataset and automatically making an application tax payment for an application tax which is associated with purveying the application.

7. The configured medium of claim 1, further comprising permitting cancelation of a purchase of the integrated offering only as a unified whole, as opposed to permitting cancelation of only the purchase of the dataset license or permitting cancelation of only the purchase of the application license.

8. The configured medium of claim 1, further comprising automatically reporting usage of the dataset to the dataset licensor, and separately automatically reporting usage of the application to the application licensor.

9. The configured medium of claim 1, wherein the purveying step comprises purveying the integrated offering in an online marketplace.

10. A collection of computer-readable storage media configured with data and with instructions that when executed by at least one processor causes the processor(s) to perform a computational process for integrated multi-licensor application and data purveyance, the process comprising:
identifying a dataset having a dataset licensor, the dataset having data which is subject to a schema that specifies data types and data relationships of data within the dataset;
specifying an executable application having an application licensor which is legally distinct from the dataset licensor, the application designed to operate during execution on data values that are organized according to the dataset schema and lacking a majority of its functionality in the absence of such data values;
configuring a computer-readable memory by presenting online a single integrated offering which combines the dataset and the application in a single software-only solution having a single price but having separate dataset and application licenses for the dataset and the application, respectively;
displaying the dataset license in a computing device;
obtaining through a user interface of the computing device a purchaser's consent to be bound by the dataset license;
displaying the application license in the computing device; and
obtaining through the device's user interface the purchaser's consent to be bound by the application license.

11. The computer-readable storage media of claim 10, wherein the process further comprises at least three of the following:
automatically provisioning the purchaser of the integrated offering with access to the dataset and also automatically provisioning the purchaser with the application;
receiving a single offering payment from the purchaser, automatically making a dataset licensor payment to the dataset licensor, and automatically making a separate application licensor payment to the application licensor;
receiving a single offering payment from the purchaser, automatically making a dataset tax payment for a dataset tax which is associated with purveying the dataset and automatically making an application tax payment for an application tax which is associated with purveying the application;
automatically reporting usage of the dataset to the dataset licensor, and separately automatically reporting usage of the application to the application licensor; and/or
permitting cancelation of a purchase of the integrated offering only as a unified whole, as opposed to permitting cancelation of only the purchase of the dataset license or permitting cancelation of only the purchase of the application license.

12. The computer-readable storage media of claim 10, wherein the process further comprises the following:
automatically provisioning the purchaser of the integrated offering with access to the dataset and also automatically provisioning the purchaser with the application, the dataset containing at least one hundred megabytes of data; and
receiving a single offering payment from the purchaser, automatically making a dataset licensor payment to the dataset licensor, and automatically making a separate application licensor payment to the application licensor.

13. A computer system comprising:
a logical processor;
a memory in operable communication with the logical processor;
an integrated offering residing in the memory and consisting substantially of licenses as opposed to hardware, the integrated offering including at least one dataset end-user license which identifies a dataset licensor and also including at least one application end-user license which identifies an application licensor that is branded separately from the dataset licensor, the dataset license(s) and the application license(s) combined in a single solution having a single price;
a user interface residing in the memory; and
a purveyor code which upon execution by the processor will perform a process for integrated multi-licensor application and data purveyance that includes at least obtaining through the user interface a purchaser's consent to be bound by the dataset license and also separately obtaining through the user interface the purchaser's consent to be bound by the application license.

14. The system of claim 13, wherein the dataset license permits access to at least one of the following:
a dataset which contains at least two hundred megabytes of data;
a dataset which contains at least one hundred thousand data records;
a dataset which contains data from each of at least five years;
a dataset which contains data from each of at least five hundred counties;
a dataset which contains data from each of at least twenty countries;
a dataset which contains data for each of at least six schema columns.

15. The system of claim 13, wherein the dataset license permits access to at least one of the following:
a dataset which contains weather data;
a dataset which contains stock and/or bond data;
a dataset which contains housing cost data;
a dataset which contains demographic data;
a dataset which contains commodities price data;
a dataset which contains financial product usage data;
a dataset which contains latitude-longitude data;
a dataset which contains telephone number data;
a dataset which contains company name data;
a dataset which contains email address data;
a dataset which contains sports data;
a dataset which contains social media data;
a dataset which contains web search related data.

16. The system of claim 13, wherein the integrated offering is offered in at least one of the following:
a public online marketplace;
a website of the dataset licensor;
a website of the application licensor.

17. The system of claim 13, wherein the purveyor code upon execution will perform at least one of the following purveyance activities:
automatically provisioning the purchaser of the integrated offering with access to the dataset and also automatically provisioning the purchaser with the application;
receiving a single offering payment from the purchaser, automatically making a dataset licensor payment to the dataset licensor, and automatically making a separate application licensor payment to the application licensor;
receiving a single offering payment from the purchaser, automatically making a dataset tax payment for a dataset tax which is associated with purveying the dataset and automatically making an application tax payment for an application tax which is associated with purveying the application;
automatically reporting usage of the dataset to the dataset licensor, and separately automatically reporting usage of the application to the application licensor; and/or
permitting cancelation of a purchase of the integrated offering only as a unified whole, as opposed to permitting cancelation of only the purchase of the dataset license or permitting cancelation of only the purchase of the application license.

18. The system of claim 13, wherein the purveyor code upon execution will perform at least two of the purveyance activities.

19. The system of claim 13, wherein the purveyor code upon execution will perform at least four of the purveyance activities.

20. The system of claim 13, wherein the integrated offering includes at least one of the following:
two dataset licenses for two respective datasets from two respective dataset licensors, neither of whom is the application licensor, at least three licenses from at least three different licensors being present in the integrated offering, being offered in combination under a single price but with separate licenses, and being subject to cancelation only as a unified whole;
two application licenses for two respective applications from two respective application licensors, neither of whom is the dataset licensor, at least three licenses from at least three different licensors being present in the integrated offering, being offered in combination under a single price but with separate licenses, and being subject to cancelation only as a unified whole; or
two dataset licenses for two respective datasets from two respective dataset licensors and two application licenses for two respective applications from two respective application licensors, at least four licenses from at least four different licensors being present in the integrated offering, being offered in combination under a single price but with separate licenses, and being subject to cancelation only as a unified whole.
